(19) United States
(12) Patent Application Publication
(10) Pub. No.: US 2005/0090584 A1
(43) Pub. Date: Apr. 28, 2005

(54) Preparation of rubber compositions with organoclays

(76) Inventor: Clois E. Powell, Seguin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/692,007

(22) Filed: Oct. 23, 2003

(51) Int. Cl. C08K 3/34; C08K 9/10

(52) U.S. Cl. 523/210; 524/445

(57) ABSTRACT

Rubber compositions may be prepared from rubber polymers, organoclays, accelerators, activators, vulcanizates and/or combinations thereof. A rubber polymer may be combined with an organoclay to form a clay-rubber composition. The clay-rubber composition may be cured in the presence of activators accelerators, vulcanizates and/or combinations thereof. In an embodiment, a rubber polymer may be combined with a clay to form a clay-rubber composition. The clay-rubber composition may be treated with an onium compound to form an organoclay-rubber composition. Improved mechanical and/or material properties may be observed in rubber compounds containing organoclays.

### BACKGROUND

1. Field of Invention

The present invention generally relates to a rubber compound. More particularly, the invention relates to a rubber compound formed from a mixture of an organoclay intercalated with a rubber polymer.

2. Description of Related Art

Organoclays find wide application as additives in organic based systems. Organoclays may include compounds that are formed from a reaction of clay and/or clay mixtures with an onium compound. Organoclays may be combined with organic-based compositions to impart improved mechanical properties and physical properties of the organic-based composition. Preparation of materials that include an organic-based compositions and an organoclay are described in U.S. Pat. No. 4,810,734 to Kawasumi et al.; U.S. Pat. No. RE37,385 to Okada et al.; U.S. Pat. No. 4,889,885 to Usuki et al., and Japanese patent application JP 51-109998 to Fujiwara et al., all of which are incorporated by reference as if fully set forth herein.

Clays used to produce organoclays may include one or more expandable crystal lattices. Examples of clays with expanding crystal lattices are smectite and smectite-like minerals. Synthetically prepared smectite-like minerals are described in U.S. Pat. No. 3,252,757 to Granquist; U.S. Pat. No. 3,586,478 to Neuman; U.S. Pat. No. 3,666,407 to Orlemann; U.S. Pat. No. 3,671,190 to Neuman; U.S. Pat. No. 3,844,978 to Hickson; U.S. Pat. No. 3,844,979 to Hickson; U.S. Pat. No. 3,852,405 to Granquist and U.S. Pat. No. 3,855,147 to Granquist, all of which are incorporated by reference as if fully set forth herein. Laponite® (manufactured by Southern Clay, Gonzales, Tex.) is an example of synthetically prepared smectite-type clay.

Organoclays may be used to thicken (e.g., gel) organic compositions. In addition, organoclays may be used as rheological additives in organic compositions and/or solvents (e.g., toluene). Preparation and properties of organoclays used as thickeners and/or rheological additives are described in U.S. Pat. No. 2,531,427 to Hauser; U.S. Pat. No. 2,966,506 to Jordan; U.S. Pat. No. 3,974,125 Oswald et al.; U.S. Pat. No. 3,537,994 to House and U.S. Pat. No. 4,081,496 to Finlayson, all of which are incorporated by reference as if fully set forth herein.

Organoclays may be used to in conjunction with reinforcement additives (e.g., carbon black, silica) to reinforce thermoplastic or thermosetting polymers. Preparation and properties of organoclays in conjunction with reinforcement additives of thermoplastic or thermosetting polymers is described in U.S. Pat. No. 6,598,645 to Larsen; U.S. Patent Application No. 20030032710 to Larson; U.S. Patent Application No. 20030004250 to Ajbani et al., all of which are fully incorporated by reference as if fully set forth herein.

### SUMMARY

In an embodiment, a rubber compound that does not include carbon black, silica, silica treated carbon black or mixtures thereof may be prepared by combining an organoclay with a rubber polymer to form an organoclay-rubber composition. At or below a temperature of 200° C., the organoclay-rubber composition may be contacted with an activator to form an organoclay-rubber/activator mixture. The clay-rubber/activator mixture may be contacted with an accelerator and/or a vulcanizate at or below a temperature of 200° C. to form a rubber compound. The rubber compound may be molded into various parts (e.g., gaskets, seals, hose, tires).

In an embodiment, a rubber compound that does not include carbon black, silica, silica treated carbon black or mixtures thereof may be prepared by combining a clay with a rubber polymer to form a clay-rubber mixture. The clay-rubber mixture may be contacted with an onium ion to form an organoclay-rubber composition. At or below a temperature of 200° C., the organoclay-rubber composition may be contacted with an activator to form an organoclay-rubber/activator mixture. The organoclay-rubber/activator mixture may be contacted with an accelerator and/or a vulcanizate at or below at temperature of 200° C. to form a rubber compound. The rubber compound may be molded into various parts (e.g., gaskets, seals, hose, tires).

In certain embodiments, a rubber compound intercalated with an organoclay may impart improved material characteristics, mechanical and/or material characteristics to the rubber compound.

### BRIEF DESCRIPTION OF THE DRAWINGS

Advantages of the present invention will become apparent to those skilled in the art with the benefit of the following detailed description of embodiment and upon reference to the accompanying drawings, in which:

FIG. 1 is an x-ray diffraction spectrum of a nitrile rubber compound intercalated with an organoclay.

FIG. 2 is a graphical representation of tensile strength and elongation percent for a nitrile rubber compound reinforced with carbon black.

FIG. 3 is a representation of tensile strength and elongation percent for a nitrile rubber compound intercalated with an organoclay.

FIG. 4 is a graphical representation of tensile strength and elongation percent for a nitrile rubber compound intercalated with an organoclay.

FIG. 5 is a graphical representation of tensile strength and elongation percent for a nitrile rubber compound intercalated with an organoclay.

FIG. 6 is a graphical representation of toughness properties for nitrile rubber compounds.

While the invention is susceptible to various modifications and alternative forms, specific embodiments thereof are shown by way of example in the drawings and will herein be described in detail. It should be understood that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Rubber compounds may be used in the manufacture of tires, gaskets, seals, hoses and/or belts. In the energy industry, rubber compounds may be used to manufacturer stators, packer seals, drill pipe protectors, blow-out preventers, tank hoses, wellhead seals, valve plates and/or drill bit seals. Rubber compounds useful to the energy industry may be prepared by intercalating an organoclay with a rubber polymer to form a clay-rubber composition. In some embodiments, the clay-rubber composition may be treated with an accelerator, activator and/or vulcanizate to form the rubber compound. Improved mechanical/material properties (e.g., tensile strength, elongation percent and/or hardness) may be observed in rubber compounds intercalated with an organoclay.

A clay may include one or more individual platelets (e.g., layers) that may be intercalated. Upon intercalation, an interlayer spacing between the platelets may increase between the individual platelets. As used herein, “interlayer spacing” refers to a distance between internal faces of adjacent clay platelets as the clay platelets are assembled in a layered clay. “Intercalation,” as used herein, refers to the movement of polymer between clay platelets, where the platelets are separated, but the ordered relationship between the platelets is maintained. Interlayer spacing may be measured by techniques generally known (e.g., x-ray diffraction).

Intercalation of clay platelets may be performed using ion exchange techniques. As used herein, the term “ion exchange” refers to the interchange of ions from one substance to another. A clay that undergoes intercalation may exhibit a cation exchange capacity of between about 50 to about 200 milliequivalents per 100 grams of the clay. Cation exchange capacity may be determined using generally known methods (e.g., ammonium acetate methods such as U.S. Environmental Protection Agency Method 9080).

As used herein, the term “clay” refers to any expanding clay mineral with hydroxyl functionality, expanding clay-like mineral with hydroxyl functionality or combinations thereof. Expanding clays may include, but are not limited to, smectite, smectite-like mineral, a smectite-like cationic mineral and/or combinations thereof. As used herein, the term “smectite” or “smectite-like clay” refers to a clay with an expandable crystal lattice. Smectite clays may include, but are not limited to, montmorillonite, beidellite, nontronite, saponite, hectorite, sauconite, stevensite, sepiolite and/or combinations thereof. A smectite-like mineral may include, but is not limited, to vermiculite, mica and/or synthetically prepared smectite-like mineral.

Montmorillonite may be represented by the following chemical formula, (Si₈₋ₓAlₓ)(Al_{4-y}(Ti, Fe, Mg)_{y}O₂₀(OH)₄R⁺_{x+y}, where 0≦x≦0.4; 0.55≦y≦1.10 and R represents Na⁺, Li⁺, NH₄⁺ and/or combinations thereof.

Hectorite may be represented by a general chemical formula of: (Mg₆₋ₓLi_{X})Si₈O₂₀(OH, F)₂Rₓ⁺, where 0.57≦x≦1.15; and R represents Na⁺, Li⁺, NH₄⁺ and/or combinations thereof.

Saponite may be represented by a general chemical formula of: (Si₈₋ₓAlₓ)(Mg, Fe)₆O₂₀(OH)₄Rₓ⁺, where 0.58≦x≦1.84; and R represents Na⁺, Li⁺, NH₄⁺ and/or combinations thereof.

Stevensite may be represented by the general chemical formula of: [Mg₆₋ₓSi₈O₂₀(OH)₄]R⁺₂₋ₓ, where 0.28≦x≦0.57; and R represents Na⁺, Li⁺, NH₄⁺ and/or combinations thereof.

Beidellite may be represented by the general chemical formula of: [Al₄(Si₈₋ₓAlₓ)O₂₀(OH)₄]R⁺ₓ, where 0.55≦x≦1.10; and R represents Na⁺, Li⁺, NH₄⁺ and/or combinations thereof.

In certain embodiments, a clay may be converted to a sodium form prior to being intercalated. Conversion of the clay to the sodium form may be performed by preparing an aqueous clay slurry. The aqueous clay slurry may be contacted with a sodium exchange resin using general techniques (e.g., fluid bed reactors, ion exchange columns). As the aqueous clay contacts the sodium exchange resin, sodium cations are exchanged for cations in the clay. In other embodiments, a clay may be mixed with water and a soluble sodium compound to perform an ion exchange. The resulting ion exchanged mixture may be sheared using generally known processes (e.g., a Manton-Gaulin homogenizer, a colloid mill). Examples of soluble sodium compounds may include water-soluble sodium salts (e.g., sodium carbonate, sodium hydroxide, sodium sulfate and/or combinations thereof).

In some embodiments, a clay may be subjected to treatment by an onium compound or a combination of onium compounds to form an organoclay. An amount of onium compound or an amount of a combination of onium compounds required to treat a clay may be determined from the characteristics of the organoclay to be produced. As used herein, the term “treatment of a clay with an onium compound” refers to treating a clay or a combination of clays with one or more onium compounds. An amount of onium compound required to treat a clay may range from about 0.5 times to about 2 times the cation exchange capacity of clay based on a weight of the dry clay before any type of treatment. For example, the onium compound may be incorporated in a sufficient quantity to substantially satisfy the cation exchange capacity of a clay with the cationic activity of the onium compound. In some embodiments, an amount of onium compound used to treat a clay may be greater than a cation exchange capacity of the clay based on the cationic activity of the onium compound.

“Onium compound,” as used herein, refers to an organic compound that includes a Group VA element or a Group VIA element of the Periodic Table capable of forming one or more positive charges. Group VA and Group VIA elements include, but are not limited to, nitrogen, phosphorous or sulfur. Examples of onium compounds may include trimethyl ammonium, trimethyl phosphonium, dimethyl sulfonium or tetraethyl ammonium. Examples of multi-charged onium compounds may include tallow diamine, tallow alkylpentamethyl propylenediammonium, tris(2-hydroxyethyl)-N-tallowalkyl-1,3-diaminopropane, tallow triamine, and tallow tetramine. Multi-charged onium ions are described in U.S. Pat. No. 6,262,162 to Lan et al., which is incorporated by reference as if fully set forth herein. The anion associated with the onium compound may be a halogen or a polyatomic anion (e.g., methyl sulfate anion).

The organic portion of the onium compound may include, but is not limited to, alkyl groups, aromatic groups, alkylaryl groups, cyclic groups and/or cyclic heteroatom groups. Alkyl groups may be derived from, but are not limited to, petrochemical processes (e.g., α-olefins), animal oils, animal fats, natural oils, vegetable oils or combinations thereof. Examples of oils include tallow oil, soybean oil, coconut oil, castor oil, corn oil, cottonseed oil and/or palm oil.

Examples of aromatic groups may include, a benzyl group, a substituted benzyl group, a benzyl-type material and/or a benzylic-type material derived from a benzyl halide, a benzhydryl halide, a trityl halide, or an α-halo-α-phenylalkane. An alkane portion of the α-halo-α-phenylalkane may have an average carbon atom number ranging from 1 to 30. Examples of α-halo-α-phenylalkanes include, 1-halo-1-phenyloctadecane, substituted benzyl moieties, (e.g., derived from ortho-, meta- and para-chlorobenzyl halides), para-methoxybenzyl halides, ortho-nitrilobenzyl halide, meta-nitrilobenzyl halide, para-nitrilobenzyl halide ortho-alkylbenzyl halides, meta-alkylbenzyl halides, para-alkylbenzyl halides and/or fused ring benzyl-type moieties. An average carbon atom number of the alkyl portion of the alkylbenzyl halides may range from 1 to 30. A fused ring benzyl-type moiety may be derived from 2-halomethylnaphthalene, 9-halomethylanthracene and/or 9-halomethylphenanthrene. The halo portion of the fused ring precursor may include, but is not limited to, chloro, bromo and/or any other group that may serve as a leaving group in a nucleophilic attack of the benzyl-type moiety such that the nucleophile replaces the leaving group on the benzyl-type moiety.

Examples of other aromatic groups may include, a phenyl group, an alkyl phenyl group, a N-alkyl aniline group, a N,N-dialkyl aniline group, an ortho-nitrophenyl group, a meta-nitrophenyl group and para-nitrophenyl group. Examples of alkyl phenyl groups may include ortho-alkyl phenyl group, a meta-alkyl phenyl group and a para-alkyl phenyl group. An average carbon atom number for the alkyl portion of the alkyl phenyl group may range from 1 to 30. Additional examples of aromatic groups may include 2-halophenyl, 3-halophenyl or 4-halophenyl. The halo group may be, but is not limited to, chloro, bromo or iodo. Further examples of aromatic groups may include 2-carboxyphenyl, 3-carboxyphenyl and 4-carboxyphenyl and/or esters thereof. The alcohol portion of the ester may be derived from an alkyl alcohol. The alkyl portion of the alkyl alcohol may have an average carbon atom number ranging from 1 to 30. The alkyl portion of the alkyl alcohol may include, but is not limited to, phenol, benzyl alcohol moieties; and/or fused ring aryl moieties (e.g., naphthalene, anthracene, and phenanthrene).

Examples of cyclic heteroatom groups may include pyrrole, imidazole, thiazole, oxazole, pyridine, pyrimidine, quinoline, isoquinoline, indole, purine, benzimidazole, benzothiazole, benzoxazole, pyrazine, quinoxaline, quinazoline, acridine, phenazine, imidazopyridine and/or dipyridyl.

In an embodiment, a quaternary ammonium compound may be represented by a general chemical formula of: 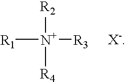
R₁ R₂, R₃ and R₄ represent an alkyl group, an aryl group, an arylalkyl group or combinations thereof. X represents an anion. Alkyl groups may include, but are not limited to, a saturated straight chain alkyl group, a saturated branched-chain alkyl group, an unsaturated branched-chain alkyl group, an unsaturated straight chain alkyl group, or combinations thereof. Alkyl groups may have an average carbon atom number ranging from 1 to 30. Aryl groups may have an average carbon atom number ranging from 7 to 22. Arylalkyl groups may have an average carbon atom number ranging from 7 to 22. The anion may include, but is not limited to, chloride, bromide, iodide, nitrite, hydroxide, nitrate, sulfate, methyl sulfate, halogenated methyl compounds or C₁ to C₁₈ carboxylate compounds acetate, phosphate or mixtures thereof. Alkyl quaternary ammonium compounds may include, but are not limited to, dimethyl di(hydrogenated tallow) ammonium chloride, methyl benzyl di(hydrogenated tallow) ammonium chloride, dimethyl benzyl hydrogenated tallow ammonium chloride, bis-hydroxyethyl methyl tallow ammonium chloride, dimethyl hydrogenated tallow-2-ethylhexyl ammonium methyl sulfate, methyl bis-2-hydroxyethyl stearyl ammonium chloride, dimethyl dibehenyl ammonium chloride and methyl tris(hydrogenated tallow) ammonium chloride.

Dimethyl di(hydrogenated tallow) ammonium chloride (2M2HT) may be represented by the chemical formula: 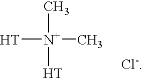
HT represents hydrogenated tallow.

Methyl bis-2-hydroxyethyl stearyl ammonium chloride (M₂HES) may be represented by the chemical formula:

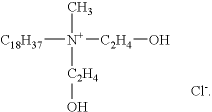

Dimethyl dibehenyl ammonium chloride may be represented by the chemical formula:

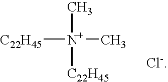

Methyl tris(hydrogenated tallow alkyl) chloride may be represented by the chemical formula: 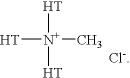
HT represents hydrogenated tallow.

In an embodiment, an organoclay may be subjected to high shearing in a suitable mill (e.g., Manton-Gaulin mill). In the mill, passing the organoclay through a narrow gap at high velocities may produce a high-speed fluid shear of the organoclay. A high-pressure differential may be maintained across the gap. The pressure differential across the gap may be less than about 8,000 psig. The organoclay may be passed through the mill one or more times. Different arrangements of the milling equipment components may be utilized to provide high shearing of the organoclay. The use of high shear may disperse the clay into individual platelets such that dispersion of the organoclay may be enhanced during addition of the organoclay to an organic matrix. Shearing of clay slurries is described in U.S. Pat. No. 5,160,454 to Knudson Jr. et al., which is incorporated by reference as if fully set forth herein. Following a high shear step, a organoclay may be subjected to other processing treatments including, but not limited to, filtering, milling and/or drying.

In an embodiment, an organoclay may be intercalated in a rubber polymer to form an organoclay-rubber composition. A rubber composition may include, but is not limited to, hydrogenated nitrile-butadiene rubber, nitrile-butadiene rubber, diene-based rubbers and/or combinations thereof. Concentrations of the amount of acrylonitrile in a nitrile rubber polymer may vary. In some embodiments, concentrations of an amount of acrylonitrile in a nitrile rubber polymer may range from about 5 wt. % to about 60 wt. %. For example Nipol 1051 manufactured by Nippon Zeon Co., Japan, may contain about 40% acrylonitrile.

A rubber polymer may be mixed with the organoclay to form a clay-rubber composition using techniques generally known in the rubber industry. Mixing of the rubber polymer and the organoclay may be performed using mixers such as, but not limited to, a thermomechanical mixer, an open mill, an internal mixer or a continuous mixer. For example, the rubber polymer and the organoclay may be mixed in a Lab Banbury mixer with a 99 cubic inch capacity manufactured by Ferro Corporation, Stryker, Ohio. Sufficient shear may be added to produce a well-blended mixture. The amount of rubber polymer and organoclay to be mixed may vary based upon the solids contents of both the organoclay and the rubber polymer. The amount of rubber polymer and organoclay to be mixed may also vary based upon the amount of clay to be intercalated in the rubber. The amount of rubber and organoclay mixed may be adjusted such that the organoclay is present in an amount less than about 500 parts by weight per hundred parts by weight rubber (pphr). In some embodiments, an amount of an organoclay may range from about 0.1 pphr to about 500 pphr in the clay-rubber mixture. In certain embodiments, an amount of an organoclay may range from about 5 pphr to about 50 pphr in the clay-rubber mixture.

Mixing of the organoclay and the rubber may be performed in a temperature range from about 30° C. to about 200° C. In some embodiments, a temperature of mixing may range from about 35° C. to about 180° C. In other embodiments, a temperature of mixing may range from about 100° C. to about 130° C.

In some embodiments, addition of an organoclay to a rubber polymer may be performed incrementally over a period of time. For example, portions of the organoclay (e.g. ½ of a organoclay, ¼ of a organoclay) may be added to the rubber over a period of time (e.g., 1 minute, 1 hour). Incremental addition of an amount of an organoclay to the rubber mixture may increase the intercalation of the organoclay in the rubber.

In an alternate embodiment, a clay may be intercalated with a rubber polymer to form a clay-rubber mixture. The clay-rubber mixture may then be contacted with an onium compound to form an organo-clay rubber composition. Mixing of the rubber polymer and the clay may be performed using mixers such as, but not limited to, a thermomechanical mixer, an open mill, an internal mixer or a continuous mixer. Sufficient shear may be added to produce a well-blended mixture. The amount of rubber polymer and clay to be mixed may vary based upon the solids contents of both the clay and the rubber polymer. The amount of rubber polymer and clay to be mixed may also vary based upon the amount of clay to be intercalated in the rubber. The amount of rubber and clay mixed may be adjusted such that the clay is present in an amount less than about 500 pphr. In some embodiments, an amount of clay may range from about 0.1 pphr to about 500 pphr in the clay-rubber mixture. In certain embodiments, an amount of clay may range from about 5 pphr to about 50 pphr in the clay-rubber mixture.

Mixing of the clay and the rubber may be performed in a temperature range from about 30° C. to about 200° C. In some embodiments, a temperature of mixing may range from about 35° C. to about 180° C. In other embodiments, a temperature of mixing may range from about 100° C. to about 130° C.

In some embodiments, addition of a clay to a rubber polymer may be performed incrementally over a period of time. For example, portions of the clay (e.g. ½ of a clay, ¼ of a clay) may be added to the rubber polymer over a period of time (e.g., 1 minute, 1 hour). Incremental addition of an amount of clay to the rubber polymer may increase intercalation of the clay in the rubber.

In some embodiments, a clay-rubber mixture may be subjected to treatment by an onium compound or a combination of onium compounds to form an organoclay-rubber composition. An amount of onium compound or an amount of a combination of onium compounds required to treat a clay-rubber mixture may be determined from the characteristics of the rubber compound to be produced. An amount of onium compound required to treat a clay-rubber mixture may range from about 0.5 times to about 2 times the cation exchange capacity of clay based on a weight of the dry clay before any type of treatment. For example, the onium compound may be incorporated in a sufficient quantity to substantially satisfy the cation exchange capacity of the clay based on the cationic activity of the onium compound. In some embodiments, an amount of onium compound used to treat a clay-rubber mixture may be greater than the cation exchange capacity of the clay based on the cationic activity of the onium compound.

In some embodiments, additives such as accelerators, activators, pigments, waxes, tackifying resins, antioxidants, antiozonants, peptizing agents, retarders or combinations thereof may be added to the rubber polymer and/or organoclay-rubber composition. Additives may be selected and used in conventional amounts depending on the final use of the rubber compound.

An organoclay-rubber composition may be treated with one or more accelerators, activators and/or vulcanizates to enhance curing of the clay-rubber composition to a rubber compound. Accelerators include, but are not limited to, aldehyde amines, guanidines, thiazoles, sulfenamides, dithiocarbamates, thiuram sulfides, xanthates or combinations thereof. Examples of aldehyde amines include hexamethylene tetraamine and ethylidene aniline. Examples of guanidine include diphenyl guanidine, triphenyl guanidine, di-o-tolyl guanidine. Examples of thiazoles include 2-mercaptobenzothiazole (MBT); 2,2′dithiobenzothiazole (MBTS); 2,4-dinitrophenylmecaptobenzothiazole or combinations thereof. Metal salts of mercaptobenzthiazole, such as a zinc or a sodium salt, may also be used as an organic accelerator. Examples of sulfenamides include N-cycolhexyl-2-benzothiazole sulfenamide (CBS); N-oxydiethylene-2-benzothiazole sulfenamide; N-t-butyl-2-benzothiazole sulfenamide (TBBS); N-dicyclohexylbenzothiazole-2-sulfenamide (DCBS); 2-morpholinothiobenzothiazole (MBS) and/or combinations thereof. Examples of dithiocarbamates include piperidine pentamethylene and/or metal salts (e.g., zinc, sodium) of diethyl dithiocarbamates and ethyl phenyl dithiocarbamates; zinc dimethyldithiocarbamate (ZDMC), zinc diethyldithiocarbamate (ZDEC) and/or combinations thereof. Examples of thiuram sulfides include tetramethyl thiuram disulfide (TMTD), tetraethyl thiuram disulfide, tetramethyl thiuram monosulfide (TMTM), dipentamethylene thiuram tetrasulfate or combinations thereof. Examples of xanthates include metal salts (e.g., zinc, sodium) of isopropyl xanthate and butyl xanthate.

Activators may increase the efficiency of the accelerators used in the process of forming a rubber compound. In the presence of an accelerator-activator pair, an increase of vulcanizing (e.g., curing) rate, reduction of vulcanization temperature and an increase of the mechanical properties of the produced rubber product may be observed. Activators may include, but are not limited to, metal oxides, fatty acids, metal salts and/or a combination thereof. Examples of metal oxides include zinc oxide, magnesium oxide, lead oxide, or tri-lead tetraoxide. Examples of fatty acids include steric acid, oleic acid, dibutyl ammonium oleate, palmitic acid linoleic acid and/or combinations thereof. Examples of metal salts include zinc stearate, zinc palmate, zinc oleate, magnesium stearate, magnesium oleate and/or combinations thereof.

Vulcanizate may increase the efficiency of the cross-linking of the rubber polymer during the curing process. Vulcanizates may include elemental sulfur and/or peroxides. Examples of peroxides include di(2,4-dichlorobenzoyl) peroxide; benzoyl peroxide; 1,1-bis(t-butylperoxy)-3,3,5-trimethyl cyclohexane; t-butyl perbenzoate; dicumyl peroxide (Di-Cup); di(t-butylperoxy)diisopropylbenzene (Vul-Cup); 2,5-dimethyl-2,5-di(t-butylperoxy)hexane; di-t-butyl peroxide; 2,5-dimethyl-2,5-di(t-butylperoxy)hexyne.

Curing of an organoclay-rubber composition may be performed by methods generally known in the rubber compounding art. Various accelerators, activators and/or vulcanizates may be added to the organoclay-rubber composition in several stages. In some embodiments, a curing activator (e.g., zinc stearate) may be added to the organoclay-rubber composition during a first stage of mixing. An amount of activator may range from about 0.1 pphr to about 5 pphr. In some embodiments, an amount of activator may range from about 0.5 pphr to about 1.5 pphr.

One or more accelerators (e.g., MBTS, NBT, and CBS) and vulcanizates (e.g. sulfur) may be added to the organoclay-rubber/activator mixture during a second stage of mixing. An amount of accelerator may range from about 0.1 pphr to about 10 pphr. In some embodiments, an amount of accelerator may range from about 1 pphr to about 3 pphr. An amount of vulcanizate may range from about 0.1 pphr to about 15 pphr. In certain embodiments, an amount of vulcanizate may range from about 2 pphr to about 4 pphr.

A temperature of curing may vary depending on an amount and/or type of activator and/or accelerator used in the curing process. In certain embodiments, an activator may be added to the organoclay-rubber composition at a temperature ranging from about 90° C. to about 150° C. The activator may be mixed for a period of time (e.g., 5 minutes). After the activator has been thoroughly mixed with the organoclay-rubber composition, one or more accelerators may be added to the resulting mixture. Once the accelerator has been added to the organoclay-rubber/activator mixture, the temperature of the resulting mixture may be adjusted to facilitate curing of the mixture to a rubber compound. In some embodiments, a temperature after addition of one or more accelerators may range from about 120° C. to about 180° C.

In some embodiments, a rubber compound may be further processed by shaping the rubber compound into various parts (e.g., gaskets, seals, hose, tires) using rolling, molding, extruding and/or other methods known in the art.

X-ray diffraction may be used to determine the extent of intercalation and/or exfoliation of the mineral layers in the organoclay-rubber composition. In powder x-ray diffraction, the D₀₀₁ peak may be monitored and distance of the spacing between the platelets may be inferred. A shape of the D₀₀₁, D₀₀₂ and D₀₀₃ peaks may be monitored and the order of the clay mineral particles may be inferred. In a composite that contains highly ordered clay platelets, a shape of the D₀₀₁, D₀₀₂ and D₀₀₃ peaks may be narrow. In a composition with highly ordered clay particles (i.e., intercalated), a value for a D₀₀₂ peak may be about one-half a value of the D₀₀₁ peak A value of a D₀₀₃ peak may be about one-third the value of the D₀₀₁ peak in a highly ordered composition.

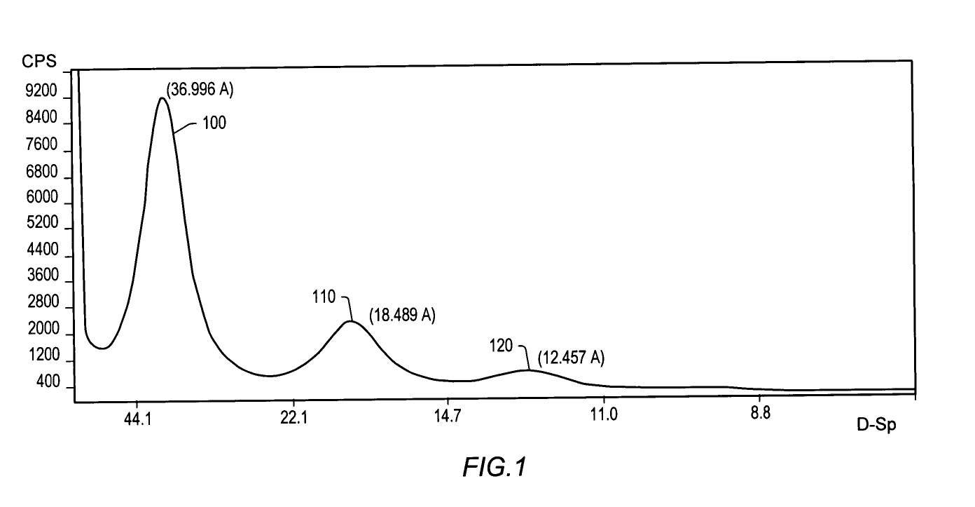

FIG. 1 is an x-ray spectrum of an organoclay intercalated in a rubber polymer. The sample was prepared by combining a clay modified with about 95 meq. of dimethyl, di(hydrogenated tallow) quaternary ammonium compound with a nitrile-rubber polymer to form an organoclay-rubber composition. Accelerators, activators, vulcanizates and/or combinations thereof may be added and the organoclay-nitrile rubber composition. The resulting mixture may be cured using general rubber curing techniques. X-ray diffraction of the organoclay-nitrile-rubber composition may indicate the level of intercalation and/or exfoliation. As shown in FIG. 1, curve 100 represents a D₀₀₁ peak, curve 110 represents a D₀₀₂ peak and curve 120 represents a D₀₀₃ peak in the x-ray spectrum. Curves 100, 110 and 120 represent spacing of clay platelets in the organoclay-nitrile-rubber composition. As depicted, shapes of D₀₀₁, D₀₀₂ and D₀₀₃ peaks are narrow. A spacing (e.g., 18.5 Å) of the D₀₀₂ peak is about 0.5 times a spacing (e.g., 37.0 Å) of the D₀₀₁ peak. A spacing of the D₀₀₃ (e.g., 12.5 Å) peak is about 0.33 times the spacing of the D₀₀₁ peak. An inference that the clay platelets of the organoclay may be highly ordered (i.e., intercalated) in the nitrile rubber polymer may be drawn.

As a value for a spacing of the D₀₀₁ peak increases, the platelets of the clay may be inferred to be highly separated in an organic matrix. In a spectra of an organoclay exfoliated (highly separated) in an organic matrix, a value for a D₀₀₁ peak may be so great that the value may not be measured using a conventional x-ray diffraction techniques for determining peak spacing. In some embodiments, D₀₀₁ peaks may be absent in an x-ray diffraction spectrum for clay platelets that are highly separated in an organic matrix. By comparison, a value for a spacing of D₀₀₁ peak in an untreated clay mineral may range from about 11 Å to about 12 Å. As determined from the spectrum in FIG. 1 (e.g., D₀₀₁ peak spacing about 37 Å), the clay platelets of the organoclay do not appear to be exfoliated in the rubber polymer.

Material/mechanical properties (e.g., hardness, tensile strength and elongation percent) of a rubber compound may be determined using techniques and instruments known in the art (e.g., durometer, tensiometer, rheometer). Typically, rubber compounds include reinforcement additives such as carbon black to meet material/mechanical properties desired by rubber product manufacturers. Reinforcement additives (e.g., fillers) may include carbon black, amorphous silica, silica treated carbon black and/or mixtures thereof.

Rubber compounds prepared with organoclays in place of reinforcement additives produced unexpected and enhanced mechanical properties in comparison to rubber compounds made with reinforcement additives. Thus, the organoclay may be used as a replacement for reinforcement additives such as carbon black in the production of rubber compounds. Rubber compounds prepared with an organoclay as a reinforcing additive in place of other types of conventional reinforcing additive may enhance material/mechanical properties of the rubber compound to be produced. In addition, replacement of the reinforcement additives with an organoclay may decrease an overall cost of producing rubber compounds.

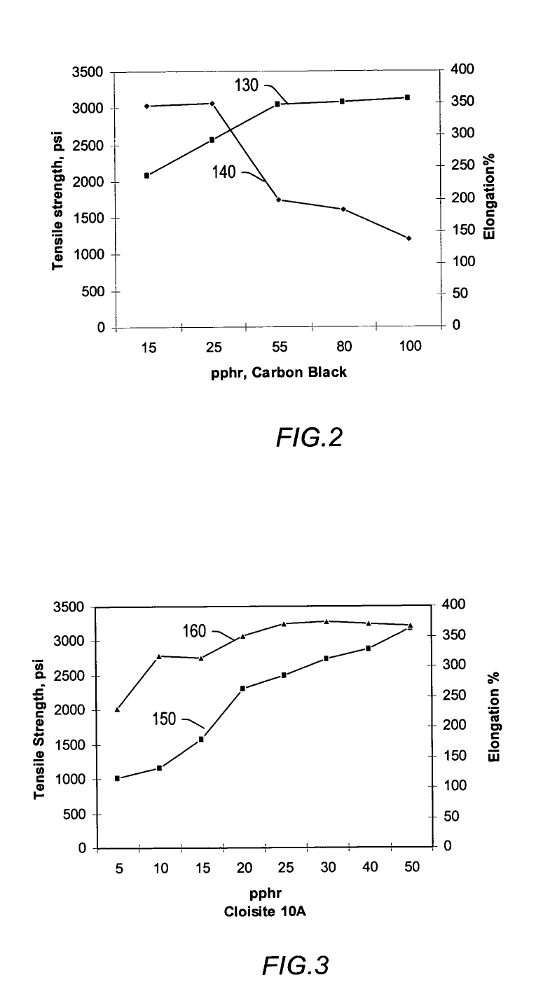

FIG. 2 through FIG. 5 are graphical representations of pounds per square inch (psi) for tensile strength and elongation percent of treated nitrile rubber compounds. Data for tensile strength and elongation percent is tabulated in Table I for nitrile rubber polymers intercalated with organoclays. Table I also includes data for nitrile rubber reinforced with carbon black. “Tensile strength,” as used herein, refers to an amount of force needed to stretch a material until the material breaks. “Elongation,” as used herein, refers to a distance a rubber compound stretches before the rubber compound breaks, as a percentage of the original dimensions of the rubber compound. 100% modulus is the force needed to stretch the rubber compound to twice its original dimensions. To increase tensile strength, an amount of reinforcement additive (e.g., carbon black) may be increased in the rubber matrix. As an amount of reinforcement additive increases in a rubber compound, the elongation properties of the rubber compound may decrease. An increase in tensile strength and decrease in elongation percent may cause failure in seals and/or gaskets at high pressures and temperatures.

FIG. 2 is a graphical representation of a nitrile rubber reinforced with carbon black and cured in the presence of conventional accelerators, activators, and vulcanizates. Curve 130 represents tensile strength measured as function of an amount of carbon black added to a nitrile rubber polymer. Curve 140 represents elongation percent measured as a function of an amount of carbon black added to a nitrile rubber polymer. As an amount of carbon black increased, an increase in tensile strength was measured and a decrease in elongation percent was measured. A tensile strength of about 2092 psi and an elongation percent of about 364 were measured for a nitrile rubber polymer reinforced with about 15 pphr carbon black and cured in the presence of conventional accelerators and activators. A tensile strength of about 3086 psi and an elongation percent of about 183 were measured for a second nitrile rubber polymer reinforced with about 80 pphr carbon black and cured in the presence of conventional accelerators, activators, and vulcanizates.

Unexpected results were obtained for tensile strength and elongation testing of a nitrile rubber polymer intercalated with an organoclay as compared to nitrile rubber compounded with a reinforcing additive (e.g., carbon black). As an amount of organoclay intercalated with a set amount of nitrile rubber increased, values measured for tensile strength and elongation percent unexpectedly increased.

FIG. 3 is a graphical representation of a nitrile rubber polymer intercalated with various amounts (e.g., 5 pphr, 10 pphr, 15 pphr, 20 pphr 25 pphr, 30 pphr, 40 pphr and 50 pphr) of a clay modified with about 125 meq. of dimethyl, benzyl, hydrogenated tallow, quaternary ammonium compound (e.g., Cloisite 10A) and cured in the presence of conventional accelerators, activators, and vulcanizates. Curve 150 represents tensile strength measured as a function of the various amounts of clay intercalated with the nitrile rubber polymer. Curve 160 represents elongation percent measured as a function of the various amounts of the modified clay intercalated with the nitrile rubber polymer. As an amount of an organoclay increased, an increase in tensile strength and elongation percent was measured. For example, a tensile strength of about 1015 psi and an elongation percent of about 296 were measured for a nitrile rubber polymer intercalated with about 5 pphr of the modified clay. A tensile strength of about 3175 psi and an elongation percent of about 368 were measured for a second sample of a nitrile rubber polymer intercalated with about 50 pphr of the modified clay.

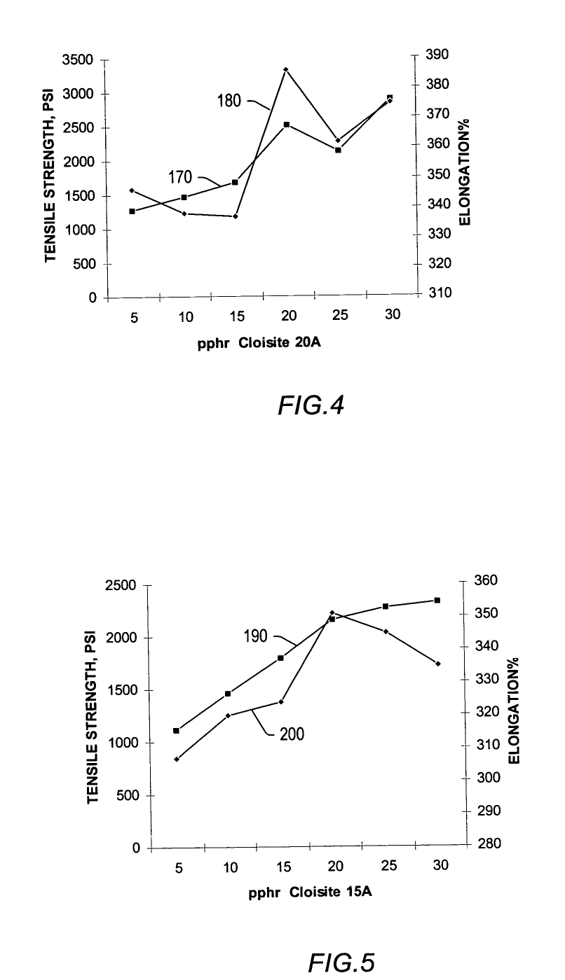

FIG. 4 is a graphical representation of a nitrile rubber polymer intercalated with various amounts (e.g., 5 pphr, 10 pphr, 15 pphr, 20 pphr 25 pphr and 30 pphr) of clay modified with about 95 meq. of dimethyl, di(hydrogenated tallow) quaternary ammonium compound (e.g., Cloisite 20A) and cured in the presence of conventional accelerators, activators and vulcanizates. Curve 170 represents tensile strength as a function of the various amount of clay for the cured nitrile rubber compound. Curve 180 represents elongation percent as a function of the various amount of clay for the cured nitrile rubber compound. As an amount of organoclay increased, an increase in tensile strength and elongation percent was measured. For example, a tensile strength of about 1367 psi and an elongation percent of about 346 were measured for a nitrile rubber polymer intercalated with about 5 pphr of the modified clay. A tensile strength of about 2892 psi and an elongation percent of about 375 were measured for a second sample of a nitrile rubber polymer intercalated with about 30 pphr of the modified clay.

In some embodiments, an amount of onium compound used to treat a clay may be varied and not have detrimental effects on material and/or mechanical properties of a resulting rubber compound. FIG. 5 is a graphical representation of a nitrile rubber polymer intercalated with various amounts (e.g., 5 pphr, 10 pphr, 15 pphr, 20 pphr 25 pphr and 30 pphr) of clay modified with about 125 meq. of dimethyl, di(hydrogenated tallow) quaternary ammonium compound (e.g., Cloisite 15A) and cured in the presence of conventional accelerators and activators. Curve 190 represents tensile strength as a function of the various amount of clay for the cured nitrile rubber compound. Curve 200 represents elongation percent as a function of the various amount of clay for the cured nitrile rubber compound. As an amount of organoclay increases, an increase in tensile strength and elongation percent was measured. For example, a tensile strength of about 1116 psi and an elongation percent of about 307 were measured for a nitrile rubber polymer intercalated with about 5 pphr of the modified clay. A tensile strength of about 2320 psi and an elongation percent of about 335 were measured for a second sample of a nitrile rubber polymer intercalated with about 30 pphr of the modified clay.

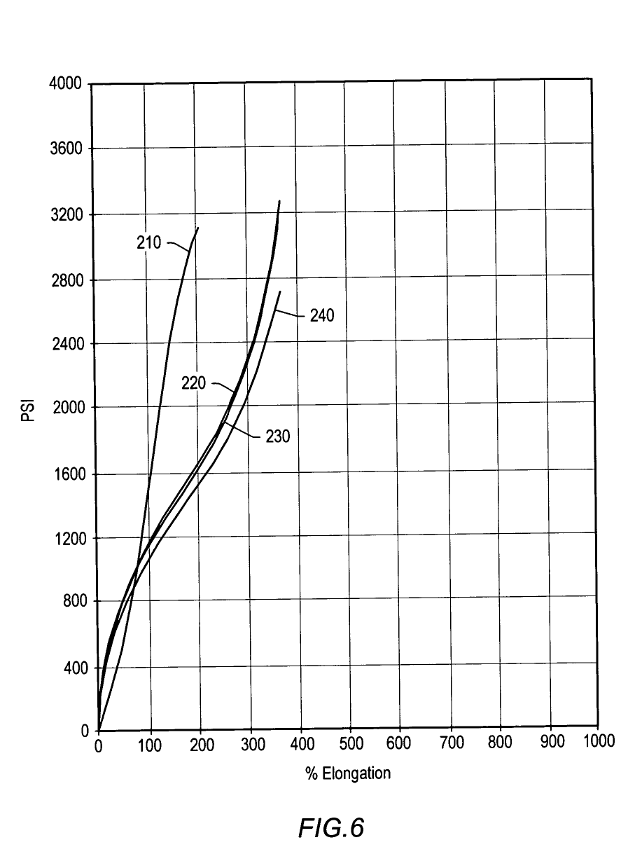

A comparison of stress (e.g., tensile strength) with strain (e.g., % elongation) may be performed to indicate toughness properties of a rubber sample. “Toughness,” as used herein, refers to the ability of a rubber compound to absorb energy before fracturing. An unexpected increase in toughness properties for nitrile rubber polymers intercalated with organoclay was measured as compared to rubber compounded with carbon black and cured under similar conditions. FIG. 6 is a graphical representation of toughness properties for a nitrile rubber compounded with carbon black and a nitrile rubber polymer intercalated with a clay modified with dimethyl, benzyl, hydrogenated tallow, quaternary ammonium. Curve 210 represents an amount of tensile strength (stress) and a percent elongation (strain) that nitrile rubber compounded with about 55 pphr carbon black may endure until the rubber sample fractures. Curves 220 and 230 represent an amount of tensile strength (stress) and a percent elongation (strain) that a nitrile rubber intercalated with about 40 pphr a clay modified with about 125 meq of dimethyl, benzyl, hydrogenated tallow, quaternary ammonium compound may endure until the rubber sample fractures. Curve 240 represents an amount of tensile strength (stress) and a percent elongation (strain) that a nitrile rubber intercalated with about 50 pphr a clay modified with about 125 meq of dimethyl, benzyl, hydrogenated tallow, quaternary ammonium compound may endure until the rubber sample fracture. “Fracture,” as used herein refers to a highest point at which the curve ends. An area under the curve may be an indicator of toughness of the rubber samples. An area under curve 210 may indicate the toughness of the nitrile rubber compounded with carbon black. Areas under curves 220, 230 and 240 may indicate the toughness of nitrile rubber compounds intercalated with the modified clay. An increase in the areas under curves 220, 230 and 240 as compared to the area under curve 210 may indicate an increase in toughness for a nitrile rubber polymer intercalated with an organoclay compared to the nitrile rubber sample compounded with carbon black.

TABLE I

| | | Tensile | Tensile | | |
|---|---|---|---|---|---|
| Organoclay | Carbon Black | Strength* | Strength** | | |
| (pphr) | (pphr) | psi | psi | Elongation* % | Elongation** % |
| — | NS 774 (15) | | 2092 | | 364 |
| — | NS 774 (25) | | 2574 | | 351 |
| — | NS 774 (55) | | 3042 | | 200 |
| — | NS 774 (80) | | 3186 | | 183 |
| — | NS 774 (100) | 3118 | | 138 | |
| Montmorillonite | — | 1015 | | 296 | |
| 125 meq of | | | | | |
| 2MBHT | | | | | |
| (5) | | | | | |
| Montmorillonite | — | 1157 | | 318 | |
| 125 meq of | | | | | |
| 2MBHT (10) | | | | | |
| Montmorillonite | — | 1576 | | 314 | |
| 125 meq of | | | | | |
| 2MBHT (15) | | | | | |
| Montmorillonite | — | | 2303 | | 350 |
| 125 meq of | | | | | |
| 2MBHT (20) | | | | | |
| Montmorillonite | — | | 2500 | | 370 |
| 125 meq of | | | | | |
| 2MBHT (25) | | | | | |
| Montmorillonite | — | | 2740 | | 375 |
| 125 meq of | | | | | |
| 2MBHT (30) | | | | | |
| Montmorillonite | — | | 2884 | | 371 |
| 125 meq of | | | | | |
| 2MBHT (40) | | | | | |
| Montmorillonite | — | | 3175 | | 368 |
| 125 meq of | | | | | |
| 2MBHT (50) | | | | | |
| Montmorillonite | — | 1367 | | 346 | |
| 95 meq of | | | | | |
| 2M2HT | | | | | |
| (5) | | | | | |
| Montmorillonite | — | 1470 | | 338 | |
| 95 meq of | | | | | |
| 2M2HT | | | | | |
| (10) | | | | | |
| Montmorillonite | — | 1675 | | 337 | |
| 95 meq of 2M2HT | | | | | |
| (15) | | | | | |
| Montmorillonite | — | | 2510 | | 386 |
| 95 meq of 2M2HT | | | | | |
| (20) | | | | | |
| Montmorillonite | — | | 2134 | | 362 |
| 95 meq of | | | | | |
| 2M2HT | | | | | |
| (25) | | | | | |
| Montmorillonite | — | | 2892 | | 375 |
| 95 meq of | | | | | |
| 2M2HT | | | | | |
| (30) | | | | | |
| Montmorillonite | — | 1116 | | 307 | |
| 125 meq of | | | | | |
| 2M2HT | | | | | |
| (5) | | | | | |
| Montmorillonite | — | 1460 | | 320 | |
| 125 meq of | | | | | |
| 2M2HT (10) | | | | | |
| Montmorillonite | — | 1789 | | 324 | |
| 125 meq of | | | | | |
| 2M2HT (15) | | | | | |
| Montmorillonite | — | | 2159 | | 351 |
| 125 meq of | | | | | |
| 2M2HT (20) | | | | | |
| Montmorillonite | — | | 2272 | | 345 |
| 125 meq of | | | | | |
| 2M2HT (25) | | | | | |
| Montmorillonite | — | | 2320 | | 335 |
| 125 meq of | | | | | |
| 2M2HT (30) | | | | | |

2MBHT: dimethyl, benzyl, hydrogenated tallow, quaternary ammonium
2M2HT: dimethyl, dehydrogenated tallow, quaternary ammonium
*Sample mixed at 120° C.
**Sample mixed at 150° C.

In an embodiment, an increase in an amount of an organoclay used to intercalate a nitrile rubber may enhance the elongation properties of a rubber compound, as compared to conventional reinforcement additives, and increasing the tensile properties of the rubber compound. Table II is a tabulation of data for a nitrile rubber polymer intercalated with different amounts and types of organoclays measured at forces necessary to stretch the material to twice and six times the original dimension (100% modulus, 300% modulus). As an amount of organoclay increases, an increase in 100% modulus was measured. For example, a 100% modulus of about 699 was measured for nitrile rubber polymer intercalated with about 30 pphr of the modified clay. A 100% modulus of about 1157 was measured for a second sample of a nitrile rubber polymer intercalated with about 50 pphr of the modified clay. As the forces necessary to stretch the material to four times the original dimension (300% modulus), nitrile rubber polymers modified with an organoclay exhibits flexibility. For example, a 300% modulus of about 2290 was measured for a nitrile rubber polymer intercalated with about 50 pphr of the modified clay. By comparison, a nitrile composite prepared with carbon black may exhibit failure (e.g., breakage) at a 300% modulus.

TABLE II

| | Carbon | | |
|---|---|---|---|
| Organoclay | Black | 100% | 300% |
| (pphr) | (pphr) | Modulus, psi | Modulus, psi |
| — | NS 774 | 305 | — |
| | (15) | | |
| — | NS 774 | 376 | — |
| | (25) | | |
| — | NS 774 | 1397 | Failed |
| | (55) | | |
| — | NS 774 | 1783 | Failed |
| | (80) | | |
| — | NS 774 | 2589 | Failed |
| | (100) | | |
| Montmorillonite treated with 125 | — | 612, 699 | 1584, 1800 |
| meq of 2MBHT (30) | | | |
| Montmorillonite treated with 125 | — | 800, 908 | 1894, 2145 |
| meq of 2MBHT (40) | | | |
| Montmorillonite treated with 125 | — | 986, 1157 | 2049, 2290 |
| meq of 2MBHT (50) | | | |
| Montmorillonite treated with 95 | — | 565, 565 | 1830, 1852 |
| meq of 2M2HT (30) | | | |
| Montmorillonite treated with 125 | — | 609, 643 | 1691, 1816 |
| meq of 2M2HT (30) | | | |

In certain embodiments, hardness of a rubber compound may be used as an indicator of reinforcement properties of a rubber compound. As a hardness value for a rubber compound increases, the rubber compound may have improved reinforcement properties. A rubber compound with improved reinforcement properties (e.g., a hardness value of about 70) may be desired in the manufacture of seals and/or gaskets. For example, rubber compounds with acceptable reinforcement properties may be used in manufacture of a packer seal for a pipe. Packer seals may need to withstand high pressures at elevated temperatures during use. Rubber compounds intercalated with organoclays may exhibit desirable tensile strength and elongation properties and maintain desirable hardness properties.

Table III is a tabulation of hardness data for nitrile rubber polymers intercalated with organoclays. Table III also includes hardness data for a nitrile rubber polymer compounded with carbon black. An increase in a reinforcement additive in the rubber polymer may increase the hardness value, but may detrimentally affect the tensile strength and elongation properties. For example, a tensile strength of about 3086 psi, an elongation percent of about 183 and a hardness value of about 84 were measured for a nitrile rubber polymer reinforced with about 80 pphr carbon black and cured with conventional accelerators and activators. A tensile strength of about 3117 psi, an elongation percent of about 138 and a hardness value of about 90 was measured for a second nitrile rubber polymer reinforced with 100 pphr carbon black and cured with conventional accelerators and activators.

As an amount of an organoclay in a rubber polymer increases, an increase in the hardness value of a rubber compound may be observed. As a hardness value of the rubber compound increases, a decrease in a tensile strength and/or elongation percent would be expected. A rubber compound intercalated with organoclay and tested for hardness value, tensile strength and elongation properties gave unexpected results. An increase in a hardness value, tensile strength and elongation properties for the rubber compound were measured. For example, a tensile strength of about 1015 psi, an elongation percent of about 296 and a hardness value of about 66 were measured for a nitrile rubber polymer intercalated with 5 pphr of a clay modified with about 125 meq. of dimethyl, benzyl hydrogenated tallow quaternary ammonium compound and cured in the presence of conventional accelerators and activators. A tensile strength of about 3175 psi, an elongation percent of about 368 and a hardness value of about 80 were measured a second sample of a nitrile rubber polymer intercalated with about 50 pphr of a clay modified with about 125 meq. of dimethyl, benzyl hydrogenated tallow quaternary ammonium compound and cured in the presence of conventional accelerators and activators.

TABLE III

| Organoclay | Carbon Black | Hardness | Hardness |
|---|---|---|---|
| (pphr) | (pphr) | Value* | Value** |
| — | NS 774 (100) | 90, 90 | — |
| — | NS 774 (80) | — | 84, 84 |
| | NS 774 (55) | | 63 |
| | NS 774 (25) | | 65 |
| | NS 774 (15) | | 80 |
| Montmorillonite | — | 66, 66 | — |
| 125 meq of 2MBHT | | | |
| (5) | | | |
| Montmorillonite | — | 70, 70 | — |
| 125 meq of 2MBHT | | | |
| (10) | | | |
| Montmorillonite | — | 74, 74 | — |
| 125 meq of 2MBHT | | | |
| (15) | | | |
| Montmorillonite | — | — | 73, 75 |
| 125 meq of 2MBHT | | | |
| (20) | | | |
| Montmorillonite | — | — | 75, 75 |
| 125 meq of 2MBHT | | | |
| (25) | | | |
| Montmorillonite | — | — | 75, 75 |
| 125 meq of 2MBHT | | | |
| (30) | | | |
| Montmorillonite | — | — | 73, 73 |
| 125 meq of 2MBHT | | | |
| (40) | | | |
| Montmorillonite | — | — | 80, 80 |
| 125 meq of 2MBHT | | | |
| (50) | | | |
| Montmorillonite | — | 65, 65 | — |
| 95 meq of 2M2HT | | | |
| (5) | | | |
| Montmorillonite | — | 69, 69 | — |
| 95 meq of 2M2HT | | | |
| (10) | | | |
| Montmorillonite | — | 73, 73 | — |
| 95 meq of 2M2HT | | | |
| (15) | | | |
| Montmorillonite | — | — | 72, 72 |
| 95 meq of 2M2HT | | | |
| (20) | | | |
| Montmorillonite | — | — | 74, 75 |
| 95 meq of 2M2HT | | | |
| (25) | | | |
| Montmorillonite | — | — | 76, 75 |
| 95 meq of 2M2HT | | | |
| (30) | | | |
| Montmorillonite | | 65, 65 | |
| 125 meq of 2M2HT | | | |
| (5) | | | |
| Montmorillonite | | 67, 67 | |
| 125 meq of 2M2HT | | | |
| (10) | | | |
| Montmorillonite | | 70, 70 | |
| 125 meq of 2M2HT | | | |
| (15) | | | |
| Montmorillonite | | | 70, 70 |
| 125 meq of 2M2HT | | | |
| (20) | | | |
| Montmorillonite | | | 70, 72 |
| 125 meq of 2M2HT | | | |
| (25) | | | |
| Montmorillonite | | | 75, 75 |
| 125 meq of 2M2HT | | | |
| (30) | | | |

*Sample mixed at 120° C.
**Sample mixed at 150° C.

In certain embodiments, dynamic mechanical testing (e.g., rheology) may be performed on an uncured rubber sample to determine a deformation and non-Newtonian flow as the rubber sample cures (e.g., stiffness). Examples of rheology tests include, scorching, storage modulus (Mh) and loss modulus (Ml). “Scorching,” as used herein, refers to the time when rubber samples begin to cure at a set temperature (Ts2). Time to achieve 90% of the final cure of the rubber sample at a set temperature is “T90.” “Storage modulus,” as used herein, refers to an elasticity component of shear modulus. “Loss modulus,” as used herein, refers to a viscosity component of shear modulus. Storage and loss modulus values may predict the stiffness of a rubber compound. Table IV is a tabulation of dynamic mechanical data for nitrile rubber compounds intercalated with organoclays. Included in Table IV is dynamic mechanical data for nitrile rubber compound with a reinforcement additive (e.g., carbon black). An increase in non-Newtonian flow properties of the rubber compound would be expected as an amount of reinforcement additive (e.g., carbon black, silica) is increased.

Unexpected results for non-Newtonian properties of a rubber compound were measured when an increased amount of organoclay was intercalated in a nitrile rubber polymer. Non-Newtonian flow properties of a nitrile rubber compound intercalated with an organoclay remained constant with an increased amount of the organoclay. For example, a loss modulus of about 0.76 psi was measured for a nitrile rubber polymer intercalated with about 5 pphr of an organoclay. A loss modulus of about 1.2 psi was measured for a nitrile rubber compound intercalated with the same organoclay at about 50 pphr. In contrast, a loss modulus of about 0.89 psi was measured for a nitrile rubber compounded with about 15 pphr of carbon black at similar scorching values to the organoclay-nitrile rubber compositions. A loss modulus of about 4.41 psi was measured for the nitrile rubber compounded with about 100 pphr of carbon black at similar scorching values to the organoclay-nitrile rubber compositions.

Nitrile rubber polymers that are reinforced with organoclays appear to demonstrate deformation and non-Newtonian flow properties similar to nitrile rubber absent other types of conventional reinforcement additives. In theory, the organoclay may reinforce a nitrile composite and not affect the deformation and non-Newtonian flow properties of the produced rubber compound because the clay may be highly oriented in one plane of the rubber polymer. Nitrile rubber compounds with constant loss modulus may provide easier molding of the nitrile rubber into seals. Seals manufactured from nitrile rubber intercalated with an organoclay may provide a more efficient seal without a sacrifice in operation performance of the seal.

TABLE IV

| | | 30′ Rheometer | | | | 30′ Rheometer | | | |
|---|---|---|---|---|---|---|---|---|---|
| | Carbon | MDR 0.5 ARC @ 150° C. | | | | MDR 0.5 ARC @ 180° C. | | | |
| Organoclay | Black | Ts2 | Ts90 | Ml | Mh | Ts2 | Ts90 | Ml | Mh |
| (pphr) | (pphr) | minutes | Minutes | psi | psi | minutes | minutes | psi | psi |
| — | — | | | | | | | | |
| — | NS 774 | 2.69 | 15.3 | 2.21 | 30.55 | — | — | — | — |
| | (15) | | | | | | | | |
| — | NS 774 | 4.33 | 17.36 | 1.06 | 17.52 | — | — | — | — |
| | (25) | | | | | | | | |
| — | NS 774 | 4.79 | 17.51 | 0.89 | 14.8 | | | | |
| | (55) | | | | | | | | |
| — | NS 774 | 2.55, 2.63 | 16.77, | 2.99, | 36.02, | 0.54, 0.55 | 3.76, | 2.13, 2.33 | 37.86, 37.96 |
| | (80) | | 16.84 | 3.17 | 36.88 | | 3.85 | | |
| — | NS 774 | 1.8, 1.99 | 17.62, | 3.98, | 45.06, | 0.43, 0.45 | 6.45, | 3.16, 3.33 | 51.34, 52.33 |
| | (100) | | 18.42 | 4.41 | 45.45 | | 6.54 | | |
| Montmorillonite treated with | — | 2.53, 2.68 | 12.93, | 0.76, | 13.94, | 0.65, 0.68 | 2.03, | 0.52, 0.51 | 13.77, 13.88 |
| 125 meq of 2MBHT | | | 13.04 | 0.76 | 14.03 | | 2.08 | | |
| (5) | | | | | | | | | |
| Montmorillonite treated with | — | 1.95, 2.03 | 11.09, | 0.84, | 14.49, | 0.58, 0.59 | 1.78, | 0.62, 0.63 | 14.12, 14.36 |
| 125 meq of 2MBHT | | | 11.62 | 0.83 | 14.49 | | 1.87 | | |
| (10) | | | | | | | | | |
| Montmorillonite treated with | — | 1.68, 1.75 | 11.24, | 0.94, | 14.80, | 0.53, 0.54 | 1.82, | 0.71, 0.70 | 14.17, 14.43 |
| 125 meq of 2MBHT | | | 12.14 | 0.93 | 14.94 | | 1.96 | | |
| (15) | | | | | | | | | |
| Montmorillonite treated with | — | 1.37, 1.23 | 10.43, | 1.02, | 11.77, | 0.5, 0.48 | 2.05, | 0.92, 1.08 | 11.87, 12.3 |
| 125 meq of 2MBHT | | | 9.86 | 1.28 | 12.8 | | 1.94 | | |
| (20) | | | | | | | | | |
| Montmorillonite treated with | — | 1.54, 1.52 | 11.7, | 1.08, | 10.56, | 0.53, 0.52 | 2.48, | 1.02, 1.0 | 11.08, 11.04 |
| 125 meq of 2MBHT | | | 11.8 | 1.04 | 10.29 | | 2.52 | | |
| (25) | | | | | | | | | |
| Montmorillonite treated with | — | 0.61, 1.65 | 12.94, | 0.84, | 8.63, | 0.56, 0.61 | 2.71, | 0.97, 0.84 | 10.59, 8.63 |
| 125 meq of 2MBHT | | | 13.09 | 1.09 | 8.78 | | 2.94 | | |
| (30) | | | | | | | | | |
| Montmorillonite treated with | | 1.55, 1.43 | 14.58, | 1.17, | 11.37, | 0.58, 0.48 | 2.65, | 0.99, 1.03 | 10.5, 10.51 |
| 125 meq of 2MBHT | | | 14.83 | 1.01 | 10.79 | | 3.31 | | |
| (40) | | | | | | | | | |
| Montmorillonite treated with | | 1.71 | 18.91 | 1.2 | 10.67 | 0.67, 0.73 | 3.35, | 0.95, 1.0 | 9.87, 10.35 |
| 125 meq of 2MBHT | | | | | | | 3.49 | | |
| (50) | | | | | | | | | |
| Montmorillonite treated with | — | 3.77, 3.66 | 14.92, | 0.82, | 13.80, | 0.8, 0.77 | 3.23, | 0.53, 0.49 | 14.12, 13.97 |
| 95 meq of 2M2HT | | | 15.13 | 0.76 | 13.79 | | 3.1 | | |
| (5) | | | | | | | | | |
| Montmorillonite treated with | — | 3.23, 3.09 | 14.87, | 0.87, | 13.92, | 0.72, 0.72 | 2.49, | 0.6, 0.59 | 13.84, 13.99 |
| 95 meq of 2M2HT | | | 14.71 | 0.86 | 14.30 | | 2.42 | | |
| (10) | | | | | | | | | |
| Montmorillonite treated with | — | 2.96, 2.78 | 13.85, | 1.04, | 14.46, | 0.69, 0.66 | 2.19, | 0.73, 0.68 | 14.22, 13.92 |
| 95 meq of 2M2HT | | | 14.28 | 0.97 | 14.25 | | 2.2 | | |
| (15) | | | | | | | | | |
| Montmorillonite treated with | — | 2.34, 2.21 | 10.39, | 1.44, | 13.62, | 0.68, 0.68 | 2.1, 2.1 | 0.85, 0.85 | 13.06, 13.24 |
| 95 meq of 2M2HT | | | 10.32 | 1.41 | 13.57 | | | | |
| (20) | | | | | | | | | |
| Montmorillonite treated with | — | 2.14, 2.60 | 10.40, | 1.55, | 13.94, | 0.58, 0.65 | 1.98, | 1.13, 1.02 | 13.56, 12.79 |
| 95 meq of 2M2HT | | | 10.40 | 1.48 | 13.34 | | 2.03 | | |
| (25) | | | | | | | | | |
| Montmorillonite treated with | — | 2.98, 2.94 | 10.96, | 1.22, | 13.04, | 0.61, 0.56 | 1.99, | 1.08, 1.15 | 13.18, 13.86 |
| 95 meq of 2M2HT | | | 11.09 | 1.15 | 13.21 | | 1.87 | | |
| (30) | | | | | | | | | |
| Montmorillonite treated with | — | 3.33, 3.26 | 14.54, | 0.76, | 13.64, | 0.73, 0.73 | 2.39, | 0.49, 0.49 | 13.78, 13.72 |
| 125 meq of 2M2HT | | | 14.64 | 0.76 | 13.77 | | 2.43 | | |
| (5) | | | | | | | | | |
| Montmorillonite treated with | — | 2.32, 2.36 | 12.36, | 0.82, | 14.12, | 0.62, 0.57 | 1.88, | 0.57, 0.70 | 13.76, 13.77- |
| 125 meq of 2M2HT (10) | | | 12.30 | 0.82 | 14.05 | | 1.74 | | |
| Montmorillonite treated with | — | 1.94, 2.01 | 10.88, | 0.93, | 14.1, | 0.57, 0.58 | 1.74, | 0.70, 0.64 | 13.78, 13.24 |
| 125 meq of 2M2HT (15) | | | 11.57 | 0.82 | 12.25 | | 1.86 | | |
| Montmorillonite treated with | — | 1.68, 1.66 | 9.53, | 1.12, | 13.82, | 0.53, 0.52 | 1.82, | 0.92, 0.89 | 13.85, 13.223 |
| 125 meq of 2M2HT (20) | | | 9.56 | 1.07 | 13.04 | | 1.77 | | |
| Montmorillonite treated with | — | 1.77, 1.46 | 10.26, | 1.03, | 13.02, | 0.56, 0.51 | 1.96, | 0.82, 1.01 | 12.85, 13.12 |
| 125 meq of 2M2HT (25) | | | 10.14 | 1.31 | 13.82 | | 1.95 | | |
| Montmorillonite treated with | — | 1.60, 1.49 | 10.71, | 1.30, | 13.03, | 0.52, 0.51 | 2.02, | 1.00, 1.12 | 12.55, 12.09 |
| 125 meq of 2M2HT (30) | | | 10.20 | 1.29, | 12.26 | | 1.93 | | |

In some embodiments, thermal gravimetric analysis (TGA) may be performed as an indicator of thermal stability properties of a rubber compound. Increased thermal stability properties were measured when an organoclay was intercalated in a nitrile rubber polymer as compared to a carbon black filled rubber compound. For example, a thermal decomposition temperature value of about 500° C. was measured for a nitrile rubber polymer intercalated with 50 pphr of dimethyl, benzyl, hydrogenated tallow quaternary ammonium. In contrast, a thermal decomposition temperature value of about 465° C. was measured for a nitrile rubber compounded with about 55 pphr of carbon black. Generally, it has been found that rubber compounds made using an organoclay compound have a higher thermal decomposition temperature than the same rubber compositions made using carbon black.

The following examples serve to illustrate methods of producing a nitrile rubber compound intercalated with a organoclay. The examples should not be considered limiting.

### EXAMPLE 1

Control. Nitrile rubber polymer (100 pphr, Nipol 150, Nippon Zeon Co., Japan, 41% acrylonitrile content) was added to a Ferro Lab Banbury mixer (fill factor 60%). Carbon black (100 pphr, NS 774) was added to the nitrile rubber polymer in two equal portions at a temperature less than 120° C. A first portion of carbon black was added to the nitrile rubber polymer and contacted for about 0.5 minutes. A second portion of carbon black, equal in amount to the first portion of carbon black, was added to the carbon black/nitrile rubber mixture. The resulting carbon black/nitrile rubber mixture was contacted at a temperature of less than 120° C. for about 0.5 minutes. Steric acid (2 pphr) and zinc oxide (2 pphr, Kadox 920, Zinc Corporation of America; Monaca, Pa.) were added to the carbon black/nitrile rubber mixture at a temperature of less than 120° C. for about 3.5 minutes. The resulting mixture was removed from the mixer over a period of time (about 2 minutes) and passed through a two-roll mill six times.

The rubber mixture, sulfur (3.5 pphr) and MBTS (2 pphr, 2,2-benzothiazole disulfide) were added back to a Banbury mixer and mixed until the temperature reached about 200° F. The resulting rubber mixture was removed from the mixer over a period of time (about 2 minutes). The resulting nitrile rubber compound was cured at about 150° C. in a press for about 30 minutes at a pressure of about 2,400 psi on a 16 inch diameter plate to form a rubber compound.

### EXAMPLE 2

Nitrile rubber (100 pphr, Nipol 150, Nippon Zeon Co., Japan, 41% acrylonitrile content) and 5 pphr of montmorillonite modified with about 125 meq of dimethyl, benzyl, hydrogenated tallow, quaternary ammonium compound (Cloisite® 10A manufactured by Southern Clay Products, Gonzales, Tex.) was added incrementally to the nitrile rubber polymer in equal portions (e.g., 2.5 pphr each). A first portion of the organoclay was added to the Banbury mixer and contacted with the nitrile rubber polymer at a temperature less than 120° C. for about 0.5 minutes. A second portion of the organoclay, equal in amount to the first portion of the organoclay, was added to the organoclay-nitrile rubber composition. The resulting organoclay-nitrile rubber composition was mixed at a temperature of less than 120° C. for about 0.5 minute. The organoclay-nitrile rubber composition was mixed for about 3.5 minutes at a temperature of less than 120° C. Zinc stearate (1 pphr) was added to the organoclay-nitrile rubber composition. The resulting zinc stearate/organoclay-nitrile rubber mixture was removed from the mixer over a period of time (about 5 minutes) and passed through a two-roll mill six times.

The zinc stearate/organoclay-nitrile rubber mixture, sulfur (3.5 pphr) and MBTS (2 pphr) were added to a Banbury mixer and mixed for three minutes at a temperature of less than about 90° C. The resulting zinc stearate/organoclay-nitrile rubber composition was removed from the mixer after mixing for about 5 minutes, at a temperature less than about 120° C. The rubber was passed through a two-roll mill six times. The rubber compound was cured at 150° C. in a press for about 30 minutes at a pressure of about 2,400 psi on a 16 inch diameter plate to form a nitrile rubber compound.

### EXAMPLE 3

A nitrile rubber compound was prepared in the same manner as in Example 2, except 10 pphr of the modified clay was used.

### EXAMPLE 4

A nitrite rubber compound was prepared in the same manner as in Example 2, except 15 pphr of the modified clay was used.

### EXAMPLE 5

Nitrile rubber (100 pphr, Nipol 150, Nippon Zeon Co., Japan, 41% acrylonitrile content) and 5 pphr of montmorillonite modified with about 95 meq of dimethyl-di(hydrogenated tallow) quaternary ammonium compound (Cloisite® 20A manufactured by Southern Clay Products, Gonzales, Tex.) was added to the nitrile rubber polymer in equal portions (e.g., 2.5 pphr each). A first portion of the organoclay was added to the Banbury mixer and contacted with the nitrile rubber polymer at a temperature less than 120° C. for about 0.5 minutes. A second portion of the organoclay, equal in amount to the first portion of the organoclay, was added to the organoclay-nitrile rubber composition. The resulting organoclay-nitrile rubber composition was mixed at a temperature of less than 120° C. for about 0.5 minute. The organoclay-nitrile rubber composition was mixed for about 3.5 minutes at less than 120° C. Zinc stearate (1 pphr) was added to the organoclay-nitrile rubber composition. The resulting zinc stearate/organoclay-nitrile rubber mixture was mixed for about 3.5 minutes. The resulting zinc stearate/organoclay-nitrile rubber mixture was removed from the mixer over a period of time (about 5 minutes) and passed through a two-roll mill six times.

The zinc stearate/organoclay-nitrile rubber mixture, sulfur (3.5 pphr) and MBTS (2 pphr) were added to a Banbury mixer and mixed at a temperature of less than about 90° C. The rubber was passed through a two-roll mill six times. The resulting rubber polymer was removed from the mixer over a period of time (about 3.0 minutes). The rubber compound was cured at 150° C. in a press for about 30 minutes at a pressure of about 2,400 psi on a 16 inch diameter plate to form a nitrile rubber compound.

### EXAMPLE 6

A nitrile rubber compound was prepared in the same manner as in Example 5, except 10 pphr of the modified clay was used.

### EXAMPLE 7

A nitrile rubber compound was prepared in the same manner as in Example 5, except 15 pphr of the modified clay was used.

### EXAMPLE 8

Nitrile rubber (100 pphr, Nipol 150, Nippon Zeon Co., Japan, 41% acrylonitrile content) and 5 pphr of montmorillonite modified with about 125 meq of dimethyl-di(hydrogenated tallow) quaternary ammonium compound (Cloisite® 15A manufactured by Southern Clay Products, Gonzales, Tex.) was added to the nitrile rubber polymer in equal portions (e.g., 2.5 pphr each). A first portion of the organoclay was added to the Banbury mixer and contacted with the nitrile rubber polymer at a temperature less than 120° C. for about 0.5 minutes. A second portion of the organoclay, equal in amount to the first portion of the organoclay, was added to the organoclay-nitrile rubber composition. The resulting organoclay-nitrile rubber composition was mixed at a temperature of less than 120° C. for about 0.5 minutes. The organoclay-nitrile rubber composition was mixed for about 3.5 minutes at a temperature of less than 120° C. Zinc clay stearate (1 pphr) was added to the organoclay-nitrile rubber composition. The resulting zinc stearate/organoclay-nitrile rubber mixture was mixed for about 3.5 minutes. After mixing, the resulting zinc stearate/organoclay-nitrile rubber mixture was removed from the mixer and passed through a two-roll mill six times.

The zinc stearate/organoclay-nitrile rubber mixture, sulfur (3.5 pphr) and MBTS (2 pphr) was added to a Banbury mixer and mixed at a temperature of less than about 90° C. The resulting rubber polymer was removed from the mixer over a period of time (about 3.0 minutes). The nitrile rubber compound was cured at 150° C. in a press for about 30 minutes at a pressure of about 2,400 psi on a 16 inch diameter plate to form a nitrile rubber compound.

### EXAMPLE 9

A nitrile rubber compound was prepared in the same manner as in Example 8, except 10 pphr of the modified clay was used.

### EXAMPLE 10

A nitrile rubber compound was prepared in the same manner as in Example 8, except 15 pphr of the modified clay was used.

### EXAMPLE 11

Control. Nitrile rubber (100 pphr, Nipol 150, Nippon Zeon Co., Japan, 41% acrylonitrile content) was added to a Banbury mixer. Carbon black (80 pphr NS 774) was added to the nitrile rubber polymer in four equal portions (20 pphr each). A first portion of carbon black was added to the Banbury mixer. The carbon black/nitrile rubber mixture was contacted at a temperature less than 150° C. for about 0.5 minutes. A second portion of carbon black, equal in amount to the first portion of carbon black, was added to the carbon black-nitrile rubber mixture. The resulting carbon black-nitrile rubber mixture was contacted at a temperature of less than 150° C. for about 1.0 minute. A third portion of carbon black, equal in amount to the first portion of carbon black, was added to the carbon black/nitrile rubber mixture. The resulting mixture was contacted at a temperature of less than 150° C. for about 1.0 minute. A fourth portion of carbon black, equal in amount to the first portion of carbon black, was added to the carbon black/nitrile rubber mixture. The resulting carbon black/nitrile rubber mixture was contacted at a temperature of less than 150° C. for about 1.0 minute. The carbon black nitrile rubber mixture was contacted at a temperature of less than 150° C. for an additional period of time (about 5.0 minutes). Stearic acid (2 pphr) and zinc oxide (2 pphr, Kadox 920, Zinc Corporation of America, Monaca, Pa.) were added to the carbon black/nitrile rubber mixture and the mixture was mixed for about 3.5 minutes at a temperature of less than 120° C. The resulting rubber mixture was removed from the mixer (after mixing for about 5 minutes) and passed through a two-roll mill six times.

The zinc stearate/organoclay-nitrile rubber mixture, sulfur (3.5 pphr) and MBTS (2 pphr) was added to a Banbury mixer and mixed at a temperature of less than about 90° C. The resulting rubber mixture was removed from the mixer (after mixing for about 2 minutes). The resulting nitrile rubber compound was cured at 120° C. in a press for about 30 minutes at a pressure of about 2,400 psi on a 16 inch diameter plate to form a rubber compound.

### EXAMPLE 12

Nitrile rubber (100 pphr, Nipol 150, Nippon Zeon Co., Japan, 41% acrylonitrile content) and 20 pphr of montmorillonite modified with about 125 meq of dimethyl, benzyl, hydrogenated tallow, quaternary ammonium compound (Cloisite® 10A manufactured by Southern Clay Products, Gonzales, Tex.) was added to the nitrile rubber polymer in four equal portions (5 pphr each). A first portion of the organoclay was added to the Banbury mixer and mixed with the nitrile rubber polymer at a temperature less than 150° C. for about 0.5 minutes. A second portion of the organoclay, equal in amount to the first portion of the organoclay, was added to the organoclay-nitrile rubber composition. The resulting organoclay-nitrile rubber composition was mixed at a temperature of less than 150° C. for about 1.0 minute. A third portion of the organoclay, equal in amount to the first portion of organoclay, was added to the organoclay-nitrile rubber composition and mixed at a temperature of less than 150° C. for about 1.0 minute. A fourth portion of the organoclay, equal in amount to the first portion of the organoclay, was added to the organoclay-nitrile rubber composition and mixed at a temperature of less than 150° C. for about 1.0 minute. The organoclay-nitrile rubber composition was mixed for an additional period time (about 1.5 minutes) at a temperature of less than 150° C. Zinc stearate (1 pphr) was added to the organoclay-nitrile rubber composition. The resulting zinc stearate/organoclay-nitrile rubber mixture was mixed for about 2-3 minutes. After mixing, the resulting zinc stearate/organoclay-nitrile rubber mixture was passed through a two-roll mill six times.

The zinc stearate/organoclay-nitrile rubber mixture, sulfur (3.5 pphr) and MBTS (2 pphr) was added to a Banbury mixer and mixed at a temperature of less than about 95° C. The resulting rubber polymer was removed from the mixer (after mixing for about 3.0 minutes). The nitrile rubber compound was cured at 150° C. in a press for about 30 minutes at a pressure of about 2,400 psi on a 16 inch diameter plate to form a nitrile rubber compound.

### EXAMPLE 13

A nitrile rubber compound was prepared in the same manner as in Example 12, except 25 pphr of the modified clay was used.

### EXAMPLE 14

A nitrile rubber compound was prepared in the same manner as in Example 12, except 30 pphr of the modified clay was used.

### EXAMPLE 15

Nitrile rubber (100 pphr, Nipol 150, Nippon Zeon Co., Japan, 41% acrylonitrile content) and 40 pphr of montmorillonite modified with about 125 meq of dimethyl, benzyl, hydrogenated tallow, quaternary ammonium compound (Cloisite® 10A manufactured by Southern Clay Products, Gonzales, Tex.) was added to the nitrile rubber polymer in five equal portions (8 pphr each). A first portion of the organoclay was added to the Banbury mixer and mixed with the nitrile rubber polymer at a temperature less than 150° C. for about 0.5 minutes. A second portion of the organoclay, equal in amount to the first portion of the organoclay, was added to the organoclay-nitrile rubber composition. The resulting organoclay-nitrile rubber composition was mixed at a temperature of less than 150° C. for about 1.0 minute. A third portion of the organoclay, equal in amount to the first portion of organoclay, was added to the organoclay-nitrile rubber composition and mixed at a temperature of less than 150° C. for about 1.0 minute. A fourth portion of the organoclay, equal in amount to the first portion of the organoclay, was added to the organoclay-nitrile rubber composition and mixed at a temperature of less than 150° C. for about 1.0 minute. A fifth portion of the organoclay, equal in amount to the first portion of the organoclay, was added to the organoclay-nitrile rubber composition and mixed at a temperature of less than 150° C. for about 1.0 minute. The organoclay-nitrile rubber composition was mixed for an additional period time (about 1.5 minutes) at a temperature of less than 150° C. Zinc stearate (1 pphr) was added to the organoclay-nitrile rubber composition. The resulting zinc stearate/organoclay-nitrile rubber mixture was mixed for about 2-3 minutes. After mixing, the resulting zinc stearate/organoclay-nitrile rubber mixture was passed through a two-roll mill six times.

The zinc stearate/organoclay-nitrile rubber mixture, sulfur (3.5 pphr) and MBTS (2 pphr) was added to a Banbury mixer and mixed at a temperature of less than about 95° C. The resulting rubber polymer was removed from the mixer (after mixing for about 3.0 minutes). The nitrile rubber compound was cured at 150° C. in a press for about 30 minutes at a pressure of about 2,400 psi on a 16 inch diameter plate to form a nitrile rubber compound.

### EXAMPLE 16

A nitrile rubber compound was prepared in the same manner as in Example 12, except 50 pphr of the modified clay was used.

### EXAMPLE 17

Nitrile rubber (100 pphr, Nipol 150, Nippon Zeon Co., Japan, 41% acrylonitrile content) and 20 pphr of montmorillonite modified with about 95 meq of dimethyl-di(hydrogenated tallow) quaternary ammonium compound (Cloisite® 20A manufactured by Southern Clay Products, Gonzales, Tex.) was added to the nitrile rubber polymer in four equal portions (5 pphr each). A first portion of the organoclay was added to the Banbury mixer and mixed with the nitrile rubber polymer at a temperature less than 150° C. for about 0.5 minutes. A second portion of the organoclay, equal in amount to the first portion of the organoclay, was added to the organoclay-nitrile rubber composition. The resulting organoclay-nitrile rubber composition was mixed at a temperature of less than 150° C. for about 1.0 minute. A third portion of the organoclay, equal in amount to the first portion of the organoclay, was added to the organoclay-nitrile rubber composition and mixed at a temperature of less than 150° C. for about 1.0 minute. A fourth portion of the organoclay, equal in amount to the first portion of the organoclay, was added to the organoclay-nitrile rubber composition and mixed at a temperature of less than 150° C. for about 1.0 minute. The organoclay-nitrile rubber composition was mixed for an additional period time (about 1.5 minutes) at a temperature of less than 150° C. Zinc stearate (1 pphr) was added to the organoclay-nitrile rubber composition. The resulting zinc stearate/organoclay-nitrile rubber mixture was mixed for 2-3 minutes. After mixing, the resulting zinc stearate/organoclay-nitrile rubber mixture was passed through a two-roll mill six times.

The zinc stearate/organoclay-nitrile rubber mixture, sulfur (3.5 pphr) and MBTS (2 pphr) was added to a Banbury mixer and mixed at a temperature of less than about 90° C. The resulting rubber polymer was removed from the mixer (after mixing for about 3.0 minutes). The nitrile rubber compound was cured at 150° C. in a press for about 30 minutes at a pressure of about 2,400 psi on a 16 inch diameter plate to form a nitrile rubber compound.

### EXAMPLE 18

A nitrile rubber compound was prepared in the same manner as in Example 15, except 25 pphr of the modified clay was used.

### EXAMPLE 19

A nitrile rubber compound was prepared in the same manner as in Example 15, except 30 pphr of the modified clay was used.

### EXAMPLE 20

Nitrile rubber (100 pphr, Nipol 150, Nippon Zeon Co., Japan, 41% acrylonitrile content) and 20 pphr of montmorillonite modified with about 125 meq of dimethyl-di(hydrogenated tallow) quaternary ammonium compound (Cloisite® 15A manufactured by Southern Clay Products, Gonzales, Tex.) was added to the nitrile rubber polymer in four equal portions (5 pphr each). A first portion of the organoclay was added to the Banbury mixer and mixed with the nitrile rubber polymer at a temperature less than 150° C. for about 0.5 minutes. A second portion of the organoclay, equal in amount to the first portion of the organoclay, was added to the organoclay-nitrile rubber composition. The resulting organoclay-nitrile rubber composition was mixed at a temperature of less than 150° C. for about 1.0 minute. A third portion of the organoclay, equal in amount to the first portion of the organoclay, was added to the organoclay-nitrile rubber composition and mixed at a temperature of less than 150° C. for about 1.0 minute. A fourth portion of the organoclay, equal in amount to the first portion of the organoclay, was added to the organoclay-nitrile rubber composition and mixed at a temperature of less than 150° C. for about 1.0 minute. The organoclay-nitrile rubber composition was mixed for an additional period time (about 5.0 minutes) at a temperature of less than 150° C. Zinc stearate (1 pphr) was added to the organoclay-nitrile rubber composition. The resulting zinc stearate/organoclay-nitrile rubber mixture was mixed for 2-3 minutes. After mixing, the resulting zinc stearate/organoclay-nitrile rubber mixture was passed through a two-roll mill six times.

The zinc stearate/organoclay-nitrile rubber mixture, sulfur (3.5 pphr) and MBTS (2 pphr) was added to a Banbury mixer and mixed at a temperature of less than about 90° C. The resulting rubber polymer was removed from the mixer (after mixing for about 3.0 minutes). The nitrile rubber compound was cured at 150° C. in a press for about 30 minutes at a pressure of about 2,400 psi on a 16 inch diameter plate to form a nitrile rubber compound.

### EXAMPLE 21

A nitrile rubber compound was prepared in the same manner as in Example 18, except 25 pphr of the modified clay was used.

### EXAMPLE 22

A nitrile rubber compound was prepared in the same manner as in Example 18, except 30 pphr of the modified clay was used.

In this patent, certain U.S. patents and U.S. patent applications have been incorporated by reference. The text of such U.S. patents and U.S. patent applications is, however, only incorporated by reference to the extent that no conflict exists between such text and the other statements and drawings set forth herein. In the event of such conflict, then any such conflicting text in such incorporated by reference U.S. patents and U.S. patent applications is specifically not incorporated by reference in this patent.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes can be made in the elements described herein without departing from the spirit and scope of the invention as described in the following claims. In addition, it is to be understood that features described herein independently may, in certain embodiments, be combined.

1. A method of preparing a rubber polymer in the absence of carbon black, silica, silica treated carbon black or mixtures thereof, comprising;
combining an organoclay with a rubber polymer to form an organoclay-rubber composition; and
curing the organoclay-rubber composition, wherein the organoclay-rubber composition is substantially free of carbon black, silica, silica-treated carbon black or mixtures thereof.

2. The method of claim 1, wherein the rubber polymer is nitrile rubber.

3. The method of claim 1, wherein the organoclay intercalates with the rubber polymer.

4. The method of claim 1, wherein the organoclay comprises montmorillonite.

5. The method of claim 1, wherein the organoclay comprises hectorite, saponite, attapulgite, beidellite, stevensite, sauconite, nontronite, Laponite, sepiolite or combinations thereof.

6. The method of claim 1, wherein combining the organoclay with the rubber polymer comprises adding an amount of organoclay ranging from about 1 pphr to about 100 pphr to the rubber polymer.

7. The method of claim 1, wherein the organoclay comprises an onium compound.

8. The method of claim 1, wherein the organoclay comprises one or more quaternary ammonium compounds.

9. The method of claim 1, wherein the organoclay comprises one or more quaternary ammonium compounds of the general formula: 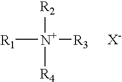
wherein R₁, R₂, R₃, and R₄ represent alkyl groups having an average carbon atom number ranging from 1 to 30, aryl groups having an average carbon atom number ranging from 7 to 22; arylalkyl groups having an average carbon atom number ranging from 7 to 22, or combinations thereof; and wherein X represents a halogen, a nitrite, a nitrate, a sulfate, a methyl sulfate, a hydroxide, a halogenated methyl compound or a C₁ to C₁₈ carboxylate.

10. The method of claim 1, wherein the organoclay comprises a multi-charged onium ion.

11. The method of claim 1, further comprising combining an activator with the organoclay-rubber composition.

12. The method of claim 1, further comprising combining an activator with the organoclay-rubber composition, wherein the activator comprises stearic acid, palmitic acid, linoleic acid or combinations thereof.

13. The method of claim 1, further comprising combining an activator with the organoclay-rubber composition, wherein the activator comprises zinc.

14. The method of claim 1, further comprising combining an activator with the organoclay-rubber composition, wherein the activator is zinc stearate.

15. The method of claim 1, further comprising combining an accelerator with the organoclay-rubber composition.

16. The method of claim 1, further comprising combining an accelerator with the organoclay-rubber composition, wherein the accelerator is mercaptobenzothiazole disulfide.

17. The method of claim 1, further comprising combining a vulcanizate with the organoclay-rubber composition.

18. The method of claim 1, further comprising combining a vulcanizate with the organoclay-rubber composition, wherein the vulcanizate is sulfur.

19. The method of claim 1, further comprising combining a vulcanizate with the organoclay-rubber composition, wherein the vulcanizate comprises one or more peroxide compounds.

20. The method of claim 1, further comprising combining an activator, an accelerator, a vulcanizate or combinations thereof with the organoclay-rubber composition.

21. The method of claim 1, wherein the rubber compound exhibits a modulus of greater than 1800 psi at an elongation percent of about 300.

22. The method of claim 1, wherein the rubber compound exhibits a tensile strength of greater than 1000 psi and a modulus greater than 1800 psi at an elongation percent of about 300.

23. The method of claim 1, wherein combining the clay with the rubber polymer occurs at a temperature less than 200° C.

24. A method of preparing a rubber compound in the absence of carbon black, silica, silica treated carbon black or mixtures thereof, comprising:
combining a clay with a rubber polymer to form a clay-rubber composition; and
combining the clay-rubber composition with an onium ion to form an organoclay-rubber composition; and
curing the organoclay-rubber composition, wherein the organoclay-rubber composition is substantially free of carbon black, silica, silica-treated carbon black or mixtures thereof.

25. The method of claim 24, wherein the rubber polymer is nitrile rubber.

26. The method of claim 24, wherein the clay comprises montmorillonite.

27. The method of claim 24, wherein the clay comprises hectorite, saponite, attapulgite, beidellite, stevensite, sauconite, nontronite, Laponite, sepiolite or combinations thereof.

28. The method of claim 24, wherein combining the clay with the rubber polymer comprises adding an amount of clay ranging from about 1 pphr to about 100 pphr to the rubber polymer.

29. The method of claim 24, wherein the onium compound comprises one or more quaternary ammonium compounds.

30. The method of claim 24, wherein the onium compound comprises one or more quaternary ammonium compounds of the general formula: 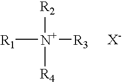
wherein R₁, R₂, R₃, and R₄ represent alkyl groups having an average carbon atom number ranging from 1 to 30, aryl groups having an average carbon atom number ranging from 7 to 22; arylalkyl groups having an average carbon atom number ranging from 7 to 22, or combinations thereof; and wherein X represents a halogen, a nitrite, a nitrate, a sulfate, a methyl sulfate, a hydroxide, a halogenated methyl compound or a C₁ to C₁₈ carboxylate.

31. The method of claim 24, wherein the onium compound comprises a multi-charged onium ion.

32. The method of claim 24, further comprising combining an activator with the organoclay-rubber composition.

33. The method of claim 24, further comprising combining an activator with the organoclay-rubber composition, wherein the activator comprises stearic acid, palmitic acid, linoleic acid or combinations thereof.

34. The method of claim 24, further comprising combining an activator with the organoclay-rubber composition, wherein the activator comprises zinc.

35. The method of claim 24, further comprising combining an activator with the organoclay-rubber composition, wherein the activator is zinc stearate.

36. The method of claim 24, further comprising combining an accelerator with the organoclay-rubber composition.

37. The method of claim 24, further comprising combining an accelerator with the organoclay-rubber composition, wherein the accelerator is mercaptobenzothiazole disulfide.

38. The method of claim 24, further comprising combining a vulcanizate with the organoclay-rubber composition.

39. The method of claim 24, further comprising combining a vulcanizate with the organoclay-rubber composition, wherein the vulcanizate is sulfur.

40. The method of claim 24, further comprising combining a vulcanizate with the organoclay-rubber composition, wherein the vulcanizate comprises one or more peroxide compounds.

41. The method of claim 24, further comprising combining an activator, an accelerator, a vulcanizate or combinations thereof with the organoclay-rubber composition.

42. The method of claim 24, wherein combining the clay with the rubber polymer occurs at a temperature less than 200° C.

43. A rubber compound substantially free of carbon black, silica, silica treated carbon black or mixtures thereof made by the process, comprising:
combining an organoclay with a rubber polymer to form a clay-rubber composition; and
curing the organoclay-nitrile composition, wherein the organoclay-rubber composition is substantially free of carbon black, silica, silica-treated carbon black or mixtures thereof.

44-64. (canceled)
